(19) United States
(12) Patent Application Publication
(10) Pub. No.: US 2011/0035624 A1
(43) Pub. Date: Feb. 10, 2011

(54) INTELLIGENT POWER CONTROL

(75) Inventor: Edward D. Miller, Legrand, CA (US)

Correspondence Address: PERKINS COIE LLP, P.O. BOX 1208, SEATTLE, WA, 98111-1208, US

(73) Assignee: Green Networks, Inc.

(21) Appl. No.: 12/850,968

(22) Filed: Aug. 5, 2010

Related U.S. Application Data
(60) Provisional application No. 61/232,310, filed on Aug. 7, 2009.

(51) Int. Cl. G06F 11/07

(52) U.S. Cl. 714/15; 714/E11.023

(57) ABSTRACT

In accordance with the techniques discussed herein, a smart monitor module (SMM) can apply the rules to information gathered about a device to determine whether a device has entered a failed state. Upon entry into the failed state, the system reboots the device to restore the device to the active state.

### CROSS-REFERENCE TO RELATED APPLICATIONS

This application claims the benefit of U.S. Provisional Application No. 61/232,310 entitled “INTELLIGENT POWER CONTROL”, filed Aug. 7, 2009, and is hereby incorporated by reference in its entirety.

### FIELD OF INVENTION

Aspects of the present teaching relate to intelligent power supplies for computer devices.

### BACKGROUND

In computing, a modem is used to connect a computing system to the internet. The modem can be connected to a router to allow more than one computer to access the internet, provide firewall protection, and offer other benefits.

At times the computer, modem, router, or other device can fail, requiring a reboot.

Once a failure is identified a manual reboot is typically performed at the device. Such a manual reboot can be performed by disabling power or instructing the device to perform the reboot. For example, a router can be rebooted by unplugging the device and then plugging it back in. Some systems can be instructed to perform a soft reboot, e.g., a computing system.

A device can be expected to fail at times, but manually rebooting can be inconvenient because the delay associated with manually rebooting the device will interrupt the use of the computing device. Further, when the computing device is located in a different location from the individual using the device, the problem can be exacerbated because of the increased delay and inconvenience in traveling to the device(s) for the reboot. Alternatively, individuals using the device may not be familiar with the process for re-booting the device, making rebooting difficult or unlikely.

For example, consider a coffee shop offering wireless internet service to patrons using a modem and router. The modem and router can be set up for use by a person of at least basic technical skill, but in day to day operations, no such person may be present to identify a failure of the router or reboot on failure. In the case that the router fails, customers are left without wireless internet service until a technically skilled person identifies the problem and reboots the router.

The foregoing examples of the related art and limitations related therewith are intended to be illustrative and not exclusive. Other limitations of the related art will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

In accordance with the techniques discussed herein, a system treats a device as having two states: failed and active. A device in an active state is monitored for entry into the failed state in accordance with various rules. A smart monitor module (SMM) can apply the rules to information gathered about the device to determine the device state. Upon entry into the failed state, the system reboots the device to restore the device to the active state.

The system can perform a method in accordance with these teachings to monitor the device for entry into the failed state, apply the rules to determine that the device has entered the failed state, and then reboot the device to restore the device from the failed state to the active state.

Advantageously, the system can reboot a failed device without user interaction. The convenience is particularly advantageous in a setting in which the device is located far away from a user such that the user must travel to the device to reboot.

### BRIEF DESCRIPTION OF THE DRAWINGS

FIG. 1 depicts an example of a system for rebooting a device upon failure.

FIG. 2 depicts a flowchart of an example of a method for rebooting a device.

FIG. 3 depicts an example of an intelligent power device.

FIG. 4 depicts a multi-directional flowchart of an example of a method for determining that a device has failed and rebooting the device.

FIG. 5 depicts an example of a system typical of the systems discussed herein.

FIG. 6 depicts an example of a power strip incorporating intelligent power control.

FIG. 7 depicts an example of an uninterruptible power supply (UPS) incorporating intelligent power control.

FIG. 8 depicts an example of a channel service unit/data service unit (CSU/DSU) incorporating intelligent power control.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

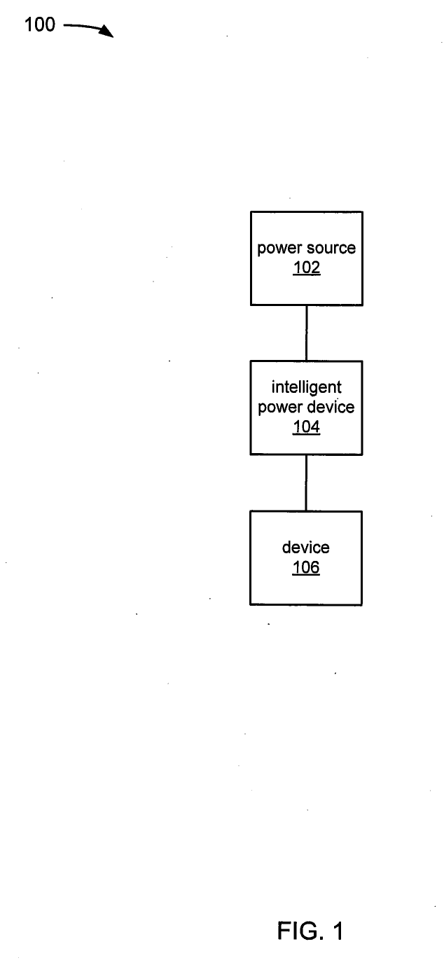

FIG. 1 depicts an example of a system 100 for rebooting a device upon failure. FIG. 1 includes power source 102, intelligent power device 104, and monitored device 106. As depicted, components 102, 104, and 106 are separate, however, the components can be combined or divided in accordance with these teachings.

In the example of FIG. 1, the power source 102 can be a 110 volt electrical outlet, 220 volt electrical outlet, battery source, or other electrical source. The power source 102 is capable of powering the device 106.

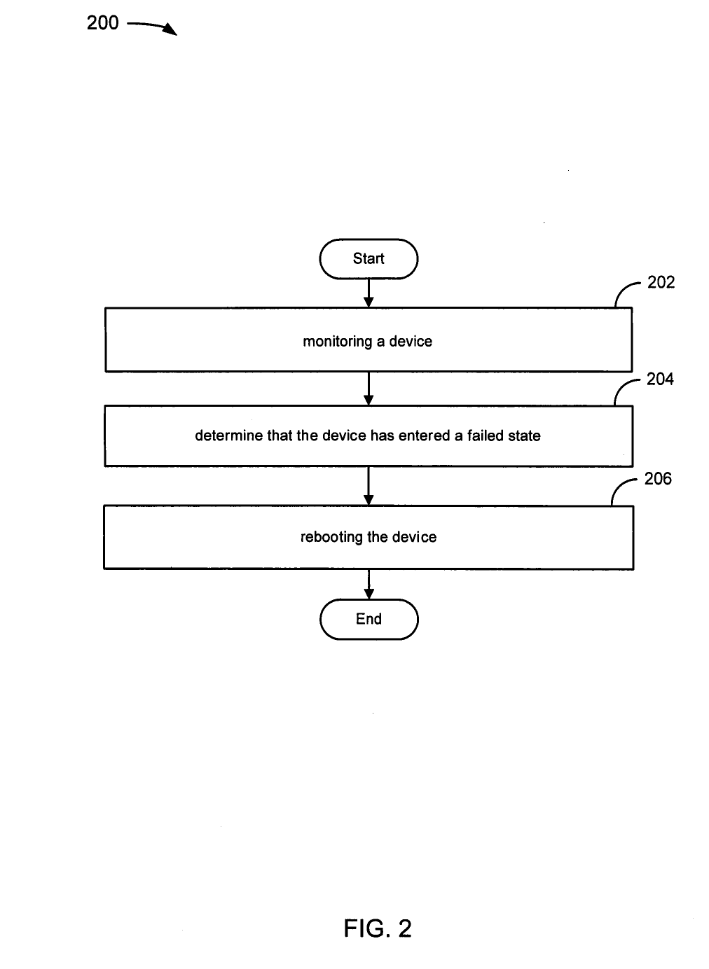

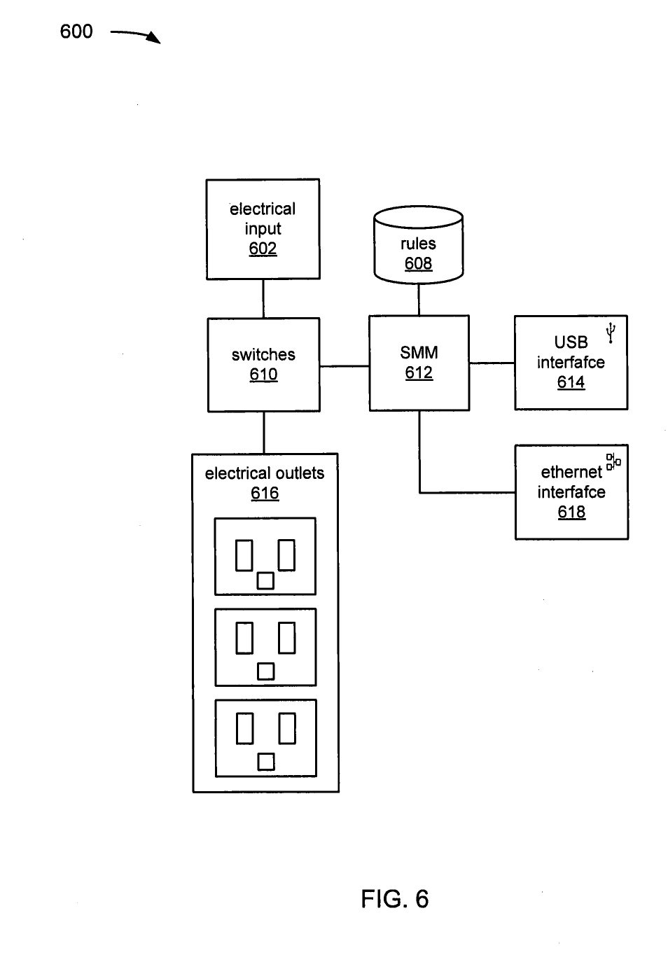

In the example of FIG. 1, the intelligent power device 104 is a system capable of monitoring the device 106 for entry into a failed state and rebooting the device 106 into an active state. The components of intelligent power device 104 are discussed in further detail in regard to FIG. 2. An example of an intelligent power device 102 device is an intelligent power strip, such as the intelligent power strip depicted in FIG. 6.

In the example of FIG. 1, the device 106 can be a modem, router, computing system, or other device having two states, an active state and a failed state. The device in a failed state can be rebooted. For example, the reboot can be accomplished by software, or alternatively, power can be temporarily disabled to reboot the device 106.

The device 106 may include specially purposed hardware, integrated circuits, software logic, or other control for executing functions of the intelligent power device 104. For example, the device 106 can execute a software client that responds to instructions issued by the intelligent power device 104. The software client could cause the device 106 to perform a soft-reboot, respond to status requests, and perform any other known or convenient function.

Further, the intelligent power device 104 can be included in the device 106. For Example, an example of a system incorporating both intelligent power device 104 and device 106 is a router. One manner of combining would be to incorporate software into the router that would cause the router to reboot into an active state from a failed state. Alternatively, a specially purposed hardware module within the router can be included to accomplish these purposes.

Another example of a system incorporating these teachings is power strip combined with a plug computer. For example, one could use the SheevaPlug Dev Kit available from Marvell Electronics of Santa Clara, Calif. A plug computer includes a microprocessor, ethernet interface, and memory. The plug computer could be connected to the modem and router, rebooting the router upon failure in accordance with the techniques discussed herein.

FIG. 2 depicts a flowchart 200 of an example of a method for rebooting a device. The method is organized as a sequence of modules in the flowchart 200. However, it should be understood that these and other modules associated with other methods described herein may be reordered for parallel execution or into different sequences of modules.

In the example of FIG. 2, the flowchart starts at module 202 with monitoring a device. The device can be passively or actively monitored. For example, consider passively collecting data indicative of the state of the device. Many devices continuously or regularly transmit data. The device can be monitored for the presence of such regular transmissions. Such data can be a simple “heartbeat” or brief message transmitted at regular intervals to a monitoring system solely to indicate proper functioning. Alternatively, such data can be data transmitted regularly as a basic function of the device, e.g. a modem transmitting data to and from an internet service provider (ISP) on behalf of a user. Further, the data could be transmitted between the device and another local device, e.g. between a router and modem facilitating communications with the other local device.

In regard to active monitoring of the device, messages can be transmitted to the device inquiring as to the status of the device. The device can then respond to indicate that it is in the active state.

In the example of FIG. 2, the flowchart continues to module 204 with determining that the device has entered a failed state. Various rules can be created from these definitions of a failed state. The rules can be used to determine that the device has entered the failed state. For example, a failure to respond could be treated as entry into the failed state. Alternatively, in some cases, the device may be able to transmit a response indicating that it is in the failed state, e.g. where the router is unable to connect to an outside provider, but remains capable of transmitting information locally. Further, in some cases infrequent responses or a number of untimely responses could indicate that the device has entered the failed state.

The rules can be combined such that a particular failed state can be identified as a basis for rebooting. For example, one rule can state that a failure to transmit for a brief period of time tends to indicate failure, but is not conclusive. This rule can be combined with a rule that states failure to respond to a transmission tends to indicates failure. Satisfaction of both rules can indicate entry into a failed state.

In the example of FIG. 2, the flowchart continues to module 206 with rebooting the device. Rebooting can involve transmitting an instruction to temporarily disable power to the device. Alternatively, rebooting can be accomplished by transmitting a software instruction to allow the device to reboot itself, e.g. where the device is a computing system and would potentially suffer damage when power is temporarily disabled. Having rebooted the device, the flowchart terminates.

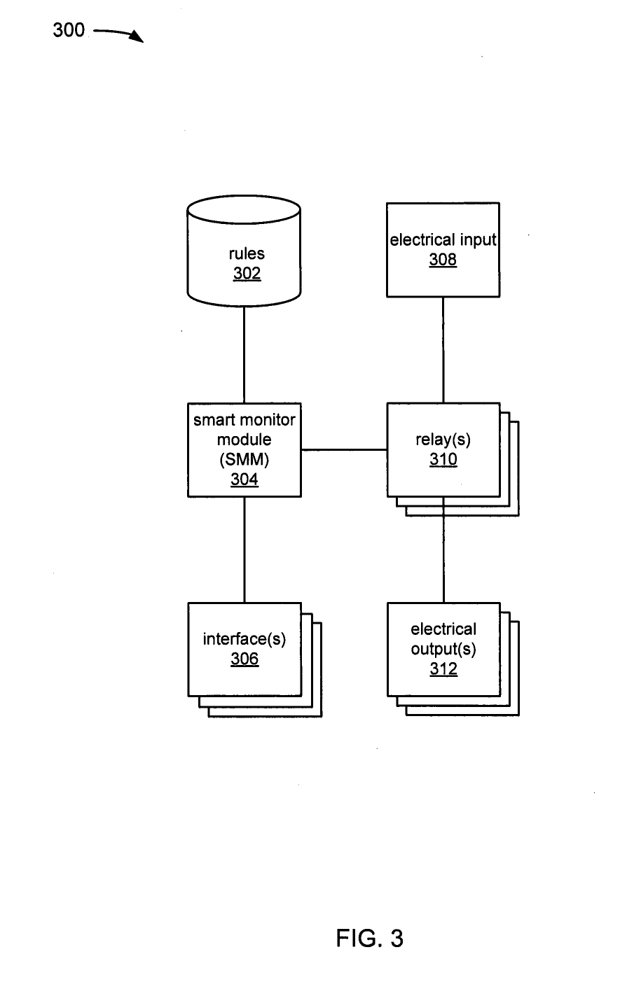

FIG. 3 depicts an example of an intelligent power device 300. FIG. 3 includes rules 302, smart monitor module (SMM) 304, interface(s) 306, electrical input 308, relay(s) 310, and electrical output(s) 312.

In the example of FIG. 3 the rules repository 302 includes various rules used to determine whether a device is in an active state or a failed state. As used in this paper, a repository can be implemented, for example, as software embodied in a physical computer-readable medium on a general- or specific-purpose machine, in firmware, in hardware, in a combination thereof, or in any applicable known or convenient device or system. The repositories described in this paper are intended, if applicable, to include any organization of data, including trees, tables, comma-separated values (CSV) files, traditional databases (e.g., SQL), or other known or convenient organizational formats.

In an example of a system where a repository is implemented as a database, a database management system (DBMS) can be used to manage the repository. In such a case, the DBMS may be thought of as part of the repository or as part of a database server, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

In the example of FIG. 3 SMM 304 can include a dedicated or shared processor and, typically, firmware or software modules that are executed by the processor. Depending upon implementation-specific or other considerations, the SMM 304 can be centralized or its functionality distributed. The SMM 304 can include or be coupled to special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware. As used herein the SMM 304 can include software implemented on hardware.

In the example of FIG. 3 interface(s) 306 can include a terminal adapter, Ethernet/IEEE 802.3 interface, wireless 802.11 interface, WiMAX/IEEE 802.16 interface, token ring IEEE 802.5 interface, Bluetooth interface, serial interface, Universal Serial Bus (USB) interface, or other interface for coupling a device to another device or computer system.

The interface(s) 306 can be used to both collect and receive data. For example, the USB interface could be used to monitor a server. The information gathered could be provided to the SMM 304, identify the server as entering a failed state, and then reboot the server, and any devices coupled to the server, e.g. a router and modem. Alternatively, the Ethernet interface could be used to gather data over a network from another device, e.g. a printer or a networked drive. The information gathered from the interface can be used to determine when the device has failed. Further, other interfaces can be used to transmit and receive data.

In the example of FIG. 3 electrical input 308 can be a power adapter sourced to a power source, e.g. 110 volt or 220 volt electrical supply.

In the example of FIG. 3 relay(s) 310 can be electrical switches, transistors, analog circuits, or other known or convenient devices for coupling electrical output(s) 312 to electrical input 308, while being able to temporarily disable power to one or more of the electrical output(s) 312 upon command.

In the example of FIG. 3 electrical output(s) 312 can be electrical sockets, connectors for sockets, internal wiring, motherboard and or daughterboard circuitry, or other known or convenient manner of supplying power to a device.

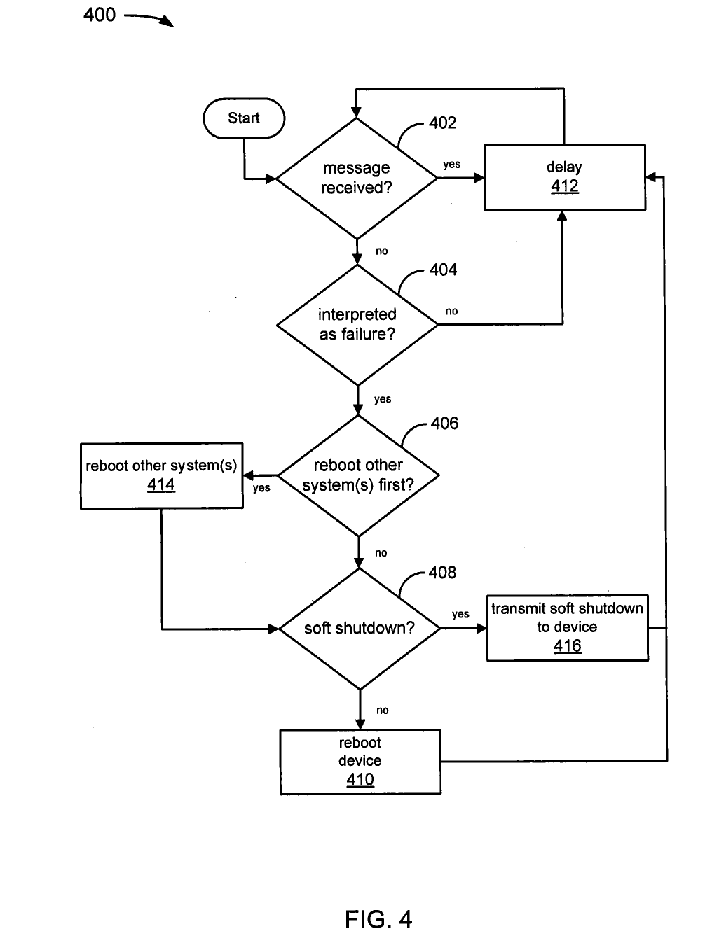

FIG. 4 depicts a multi-directional flowchart 400 of an example of a method for determining that a device has failed and rebooting the device. The method is organized as a sequence of modules in the flowchart 400. However, it should be understood that these and other modules associated with other methods described herein may be reordered for parallel execution or into different sequences of modules.

In the example of FIG. 4, the flowchart starts at module 402 with determining whether a message has been received. The message can be transmitted by a device on behalf of a user, or alternatively, can be transmitted as a heartbeat to show that the device is active. Further, the message can be transmitted in response to a request transmitted to determine whether the device is in an active state. The absence of a message for a duration of time can indicate that the message has not been received. Alternatively, the absence of a message in a sequence of messages can indicate that the message has not been received. Further any other known or convenient manner of determining that a message has not been received can be used.

In the example of FIG. 4, if the decision at 402 is yes, then the flowchart continues to module 412 with delaying a period of time. The period of time can be a time calculated to prevent the device from wasting resources and/or bandwidth by checking unnecessarily frequently, or alternatively, the period of time can be as frequent as possible to ensure that a device entering the failed state is instantaneously found. Further any other time period can be determined as is known or convenient.

In the example of FIG. 4, from module 412, the flowchart cycles back to module 402, discussed above.

In the example of FIG. 4, if the decision at 402 is no, then the flowchart proceeds to module 404 with determining whether the failure to receive a message is interpreted as a failure of the device being monitored. The determination of a failure can be made by a SMM applying a rule to data collected from the device. For example, a rule can state that an absence of a message for 2 minutes is indicative of entry into the failed state. Alternatively, the absence of a message for several minutes coupled with a failure to respond to an inquiry can be used as a combination of rules indicating entry into a failed state. Further, any other combination of rules can be used to identify entry into a failed state.

In the example of FIG. 4, if the decision at module 404 is no then the flowchart proceeds to module 412 with delaying a period of time as discussed above.

In the example of FIG. 4, alternatively, if the decision at module 404 is yes then the flowchart proceeds to module 406 with determining whether to reset other systems before resetting the failed system. Various systems and/or devices may need to be rebooted in a particular order to ensure that the device enters the active state. For example, a router may need to be rebooted prior to a modem in order to ensure that each device connects properly to a computing system for communication over the internet.

In another example, a computing system may need to be rebooted prior to a modem so that the computing system can recognize the modem. Further, any order of rebooting of various devices may need to be made in order to ensure that the particular device being monitored enters the active state.

In the example of FIG. 4, if the decision at module 406 is yes, then the flowchart proceeds to module 414 with rebooting other systems. Some devices may require that power be temporarily disabled in order to reboot the device. In order to reboot the device, the power can be temporarily disabled by, e.g. instructing a relay to disconnect a power source from an electrical outlet coupled to a particular device.

In the example of FIG. 4, from module 414, or alternatively from module 406 if the decision at module 406 is no then the flowchart proceeds to module 408 with determining whether to perform a soft shutdown. Some computing systems can be instructed to use a soft shutdown, e.g. transmitting an instruction to restart a computer running Microsoft Windows. Additionally, some routers and even modems support the soft reset function. However, for a soft shutdown command to work, the device must be functioning at least at a minimal level so that it can respond to the instruction. In some cases, a soft shutdown will produce no effect, e.g. where a computing system has “crashed,” or is otherwise disabled from executing software instructions that can restart or otherwise reboot the machine. In the case that the device cannot respond to a soft shutdown, the soft shutdown can be attempted, but it is likely that power would need to be temporarily disabled so as to cause the device to reboot.

In the example of FIG. 4, if the decision at module 408 is yes then the flowchart proceeds to module 416 with transmitting an instruction to the device to perform a soft shutdown. The instruction for the soft shutdown can be a restart command, software reset, or other known or convenient command to reboot the device.

In the example of FIG. 4 from module 416, the flowchart proceeds to module 412 with delaying a period of time as discussed above.

In the example of FIG. 4 from module 408, if the decision at module 408 is no, then the flowchart proceeds to module 410 with rebooting the device. Here, power can be temporarily disabled by, e.g. instructing a switch to de-couple a power source from an electrical outlet.

In the example of FIG. 4, from module 418, the flowchart cycles to module 412 with delaying for a period of time as discussed above. While the flowchart would otherwise terminate, here, the flowchart is not intended to terminate, instead returning the device from a failed state to an active state, as needed.

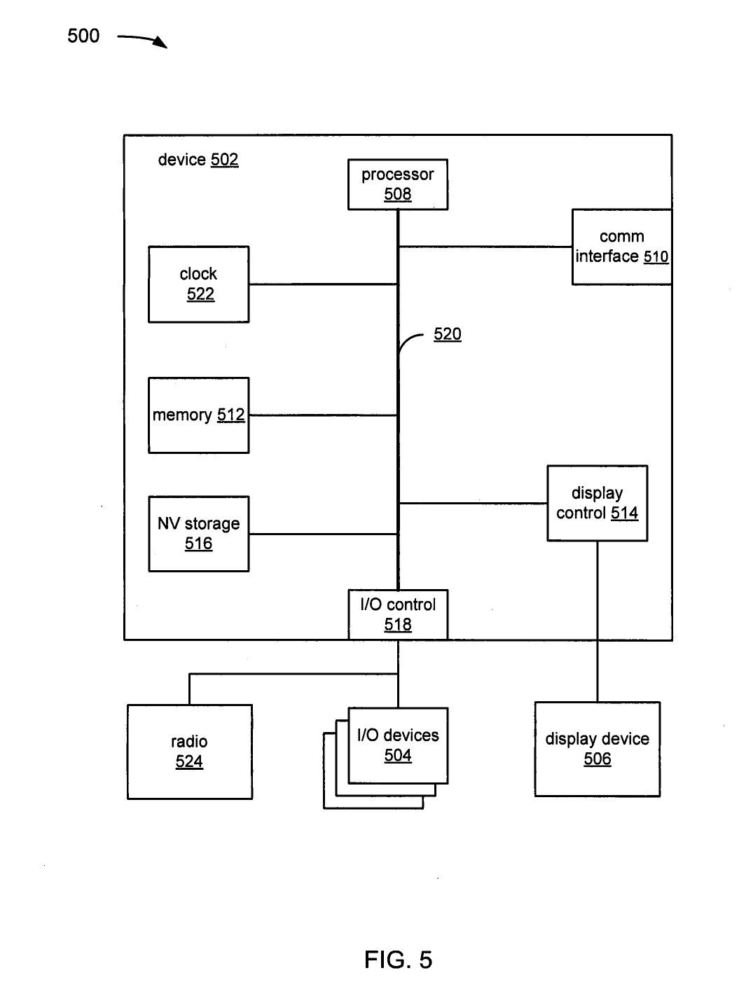

FIG. 5 depicts an example of a system 500 typical of the systems discussed herein. The system 500 may be a conventional computer system that can be used as a client computer system, such as a wireless client or a workstation, or a server computer system. The system 500 includes a device 502, I/O devices 504, and a display device 506. The device 502 includes a processor 508, a communications interface 510, memory 512, display controller 514, non-volatile storage 516, I/O controller 518, clock 522, and radio 524. The device 502 may be coupled to or include the I/O devices 504 and the display device 506.

The device 502 interfaces to external systems through the communications interface 510, which may include a modem or network interface. It will be appreciated that the communications interface 510 can be considered to be part of the system 500 or a part of the device 502. The communications interface 510 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 508 may be, for example, a conventional microprocessor such as an Intel Pentium microprocessor or Motorola power PC microprocessor. The memory 512 is coupled to the processor 508 by a bus 520. The memory 512 can be Dynamic Random Access Memory (DRAM) and can also include Static RAM (SRAM). The bus 520 couples the processor 508 to the memory 512, also to the non-volatile storage 516, to the display controller 514, and to the I/O controller 518.

The I/O devices 504 can include a keyboard, disk drives, printers, a scanner, and other input and output devices, including a mouse or other pointing device. The display controller 514 may control in the conventional manner a display on the display device 506, which can be, for example, a cathode ray tube (CRT) or liquid crystal display (LCD). The display controller 514 and the I/O controller 518 can be implemented with conventional well known technology.

The non-volatile storage 516 is often a magnetic hard disk, flash memory, an optical disk, or another form of storage for large amounts of data. Some of this data is often written, by a direct memory access process, into memory 512 during execution of software in the device 502. One of skill in the art will immediately recognize that the terms “machine-readable medium” or “computer-readable medium” includes any type of storage device that is accessible by the processor 508.

Clock 522 can be any kind of oscillating circuit creating an electrical signal with a precise frequency. In a non-limiting example, clock 522 could be a crystal oscillator using the mechanical resonance of vibrating crystal to generate the electrical signal.

The radio 524 can include any combination of electronic components, for example, transistors, resistors and capacitors. The radio is operable to transmit and/or receive signals.

The system 500 is one example of many possible computer systems which have different architectures. For example, personal computers based on an Intel microprocessor often have multiple buses, one of which can be an I/O bus for the peripherals and one that directly connects the processor 508 and the memory 512 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 512 for execution by the processor 508. A typical computer system will usually include at least a processor, memory, and a bus coupling the memory to the processor.

In addition, the system 500 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 516 and causes the processor 508 to execute the various acts required by the operating system to input and output data and to store data in memory, including storing files on the non-volatile storage 516.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

FIG. 6 depicts an example of a power strip 600 incorporating intelligent power control. The power strip 600 includes electrical outlets controlled by switches connected to an electrical input. The switches are managed by the SMM which gathers data from the USB interface and/or ethernet interface and processes the data using rules stored in the rules repository. The electrical input 602, rules 608, switches 610, SMM 612, and electrical outlets 616 discussed in reference to this figure are the same as discussed in reference to FIG. 3. Additionally, please note the power strip can incorporate a USB (universal serial bus) interface 614 and an ethernet (IEEE 802.3) interface 618.

The power strip depicted could be daisy-chained with other power strips, that is two or more power strips could be connected together with an electrical outlet of one strip used to power another strip. In this way, one outlet of a master strip could control the power for all of the outlets of a slave strip. In use, when disabling power to an outlet of the master strip all outlets of the slave strip would be disabled. As multiple devices would be plugged into the multiple outlets of the slave strip, power to the devices would be managed simultaneously by controlling a single outlet of the master strip. However, if only a single outlet of the slave strip is to be disabled then that slave strip could disable power to the specific outlet without involving the master strip. This daisy chaining can be carried out to N different strips, whereby the (N−1)th strip would control the Nth strip, the (N−2)th strip would control the (N−1)th strip and so forth all the way up to a first power strip that would control power to all other power strips.

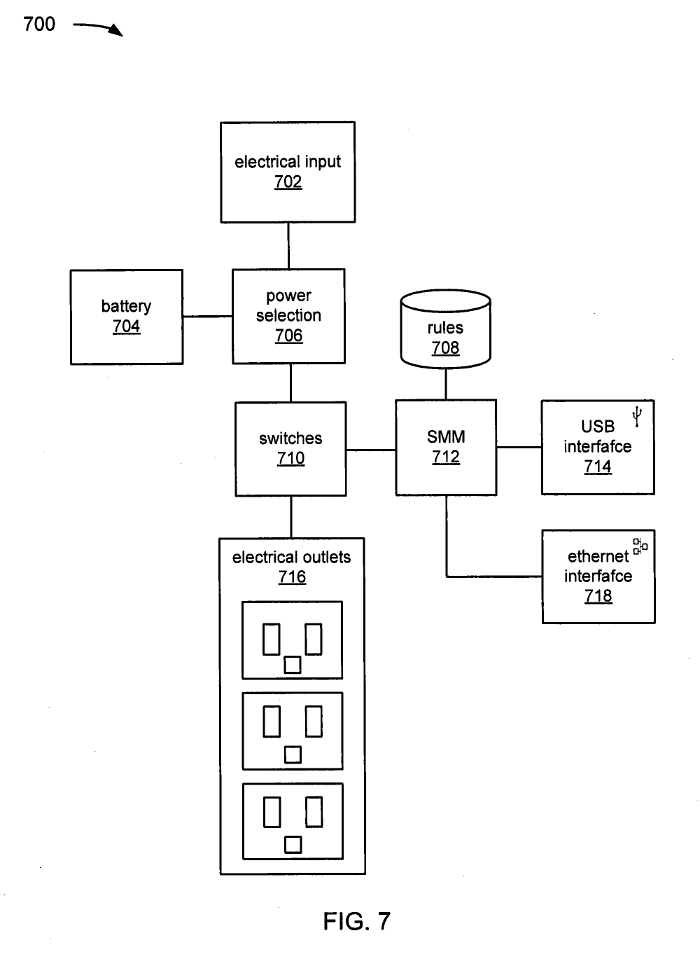

FIG. 7 depicts an example of an uninterruptible power supply (UPS) 700 incorporating intelligent power control. The UPS device can incorporate battery 704 and power selection module 706. The other components depicted are the same as discussed above.

When electrical input 702 fails to deliver electricity, power selection module 706 can respond by switching from electrical input 702 to battery 704. The battery 704 can then power the electrical outlets 716 until power is restored to electrical input 702, until the battery 704 is used up, until devices connected to electrical switches 716 turn off, or until another known or convenient time. During the use of the battery time, devices connected to the electrical outlets 716 can optionally be instructed to perform soft shutdowns, e.g. by transmitting instructions to the devices by USB interface 714, or by ethernet interface 718.

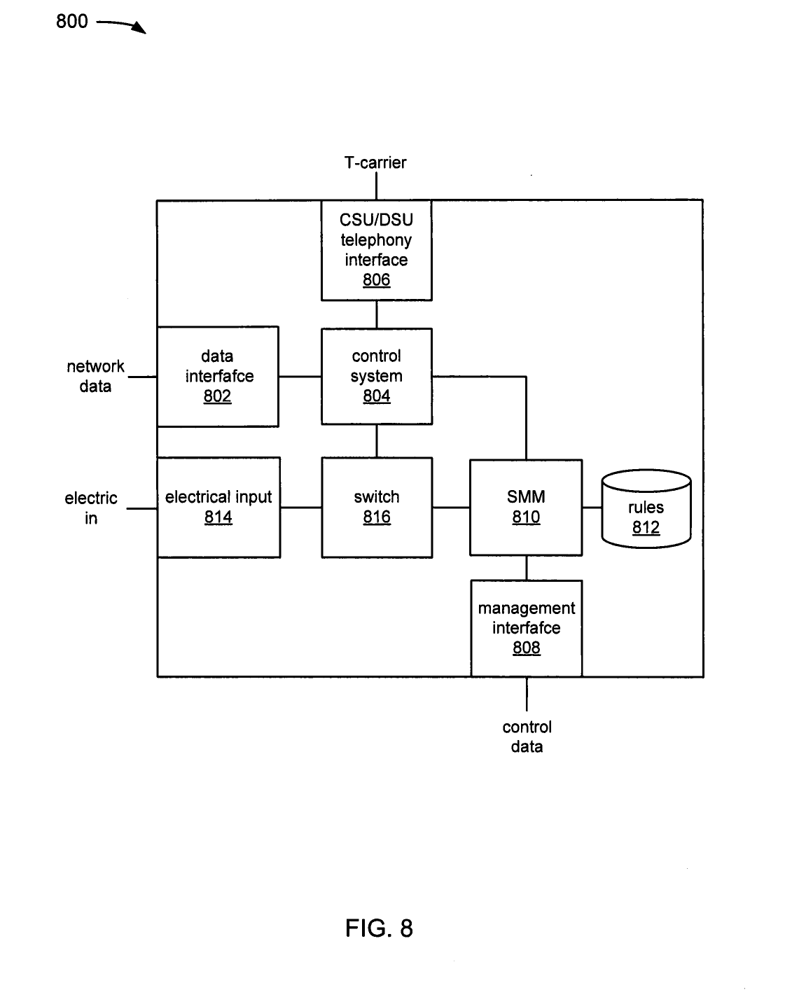

FIG. 8 depicts an example of a channel service unit/data service unit (CSU/DSU) 800 incorporating intelligent power control. The SMM 810, rules 812, electrical input 814, switches 816, and electrical outlets 818 are as discussed above. Additionally, the CSU/DSU 800 incorporates data interface 802, control system 804, CSU/DSU telephony interface 806 and management interface 808.

The data interface 802 can an Ethernet/IEEE 802.3 interface, wireless 802.11 interface, WiMAX/IEEE 802.16 interface, token ring IEEE 802.5 interface, or other known or convenient data interface. More than one data interface may be used. The control system 804 can include a processor and memory operable to convert digital data from the data interface 802 to a form for transmission over the CSU/DSU telephony interface 806. The CSU/DSU telephony interface 806 can be a device capable of transferring data between a telephone line and a local device. The T-Carrier can be for example, a T1, T3 or other physical line or part of a wide area network (WAN) accessed via, e.g. a T−1/T−3 modem or other device. The management interface 808 can be a serial interface, parallel interface, USB interface, or other connection capable of transferring local data between the CSU/DSU unit 800 and an external device, e.g. a computing system. The SMM 810 can monitor the control system 804 for failure, in a manner similar to that of a modem and/or router; however, in this case, the SMM and related components can be included in the same device as the CSU/DSU, obviating the need for external connections and multiple devices.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

It will be appreciated to those skilled in the art that the preceding examples are exemplary and not limiting. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of these teachings.

What is claimed is:

1. A method for monitoring and rebooting comprising:
monitoring a device using a smart monitor module (SMM), the device being in an active state, the SMM monitoring the device for entry into a failed state, the SMM using a rule to differentiate the active state from the failed state;
applying the rule at the SMM to determine that the device has entered the failed state; and
rebooting the device to restore the device from the failed state to the active state.

2. The method of claim 1 wherein the rule defines data emanating from the device to be determinative of the active state, and a lack of data emanating from the device as determinative of the failed state.

3. The method of claim 1 wherein the failed state is identified as a lack of response from the device for a period of time.

4. The method of claim 1 wherein rebooting comprises transmitting an instruction to the device to attempt to perform a soft reboot of the device.

5. The method of claim 1 wherein rebooting comprises temporarily disabling power to the device to perform a hard reboot of the device.

6. The method of claim 1 further comprising, rebooting a second device prior to rebooting the device.

7. A system for monitoring and rebooting a device comprising:
a smart monitor module (SMM) for determining whether a device is in an active state or a failed state, the SMM being able to reboot the device from the failed state to the active state;
a rules repository coupled to the SMM including a rule used by the SMM to determine whether the device is in the active state or in the failed state;
an electrical output coupled to and powering the device; and
a switch coupled to the SMM and coupling the electrical output to an electrical source, the switch being responsive to an order from the SMM to reboot the device by temporarily disabling power from the electrical source to the electrical output.

8. The system of claim 7 further comprising an interface coupled to the (SMM), the interface receiving a message from the device, the message useful to determine whether the device is in the active state or in the failed state.

9. The system of claim 8 wherein the interface is an ethernet interface, a universal serial bus (USB) interface, or a serial interface.

10. The system of claim 7 wherein the failed state is determined from an absence of a message for a period of time.

11. The system of claim 7 wherein the interface is used to transmit a soft reboot instruction to the device.

12. The system of claim 7 wherein the SMM instructs the switch to temporarily disable power to the device thereby performing a hard reboot.

13. The system of claim 7 further comprising, rebooting a second device prior to temporarily disabling power to the device.

14. A system for monitoring and rebooting one or more devices in order comprising:
a smart monitor module (SMM) for determining whether either or both of a router or a modem are in an active state or a failed state, the SMM being able to reboot either or both the router and modem by temporarily disabling power;
a rules repository coupled to the SMM including a rule used by the SMM to determine whether either or both the router and the modem are in the active state or in the failed state;
a first electrical outlet enabling power to the router;
a first switch coupling the first electrical outlet to a power source, the first switch being managed by the SMM to temporarily disable power to the router;
a second electrical outlet enabling power to the modem; and
a second switch managed by the SMM to control power to the modem, the second switch being managed by the SMM, the second switch being able to temporarily disable power to the modem after rebooting the router.

15. The system of claim 14 further comprising an interface, the interface being able to receive messages from either of both the router and the modem, the messages useful to determine whether either or both of the router and modem are in the active state or in the failed state.

16. The system of claim 15 wherein the interface is a serial interface, ethernet interface, or a USB interface.

17. The system of claim 14 wherein when SMM orders the switch to reboot the router prior to rebooting the modem.

18. The system of claim 14 wherein the SMM uses the rule to determine that a reboot of the modem is required, and the reboot is performed by temporarily disabling power to the second electrical outlet, thereby temporarily disabling power to the modem.

19. The system of claim 14 further comprising, a third switch coupled to a third electrical outlet, the third electrical outlet coupled to a computing system, the third switch being able to receive an instruction from the SMM to temporarily disable power to the computing system.

20. The system of claim 19 wherein the SMM attempts to instruct the computing system to perform a soft reboot as an alternative to temporarily disabling power to the computing system.
